(19) United States
(12) Patent Application Publication
(10) Pub. No.: US 2006/0218610 A1
(43) Pub. Date: Sep. 28, 2006

(54) System and method of communicating media signals in a network

(76) Inventors: Gail Jansen, Santa Ynez, CA (US); Bryce Flores, Santa Barbara, CA (US); Les Ousley, Santa Barbara, CA (US); Perry Ferguson, Montecito, CA (US); Olga Ilinichna Olivia Agapova, Santa Barbara, CA (US); Alexey Simon Ushakov, Santa Barbara, CA (US)

Correspondence Address: BRIAN M BERLINER, ESQ;O'MELVENY & MYERS, LLP, 400 SOUTH HOPE STREET, LOS ANGELES, CA, 90071-2899, US

(21) Appl. No.: 11/390,656

(22) Filed: Mar. 27, 2006

Related U.S. Application Data
(60) Provisional application No. 60/666,083, filed on Mar. 28, 2005.

(51) Int. Cl. H04N 7/173

(52) U.S. Cl. 725/105

(57) ABSTRACT

A system and method is provided for using a media control center, a data center, and a wide area network (WAN) to establish a multi-point network for transmitting, receiving and editing media. Specifically, in accordance with one embodiment of the present invention, a computer is connected to a video-camera and a data center via a local area network (LAN). The video camera is adapted to capture at least visuals, which are used to generate a first media signal. The first media signal is then sent to the data center where it is stored and transmitted to a media control center. In a first embodiment of the present invention, the media control center is adapted to edit the first media signal. In this embodiment, the media control center operates like a traditional editing studio by performing traditional editing functions, perhaps using traditional editing hardware and/or software. The edited media signal is then transmitted back to the data center where it is stored. In a second embodiment of the present invention, the media control center is further (or alternately) adapted to select a media signal(s) to be transmitted to local and/or remote users. More particularly, a media signal(s), as selected by the media control center, is transmitted from the data center to a plurality of reception devices via the LAN and/or a WAN. In another embodiment of the present invention, the data center is further adapted to receive feedback signals from the plurality of reception devices while the selected media signal(s) is being transmitted (e.g., duplex interaction, etc.). As with other media signals, the feedback signals are stored in the data center and transmitted to the media control center.

### CROSS-REFERENCE TO RELATED APPLICATION

This application claims the benefit pursuant to 35 U.S.C. §119(e) of U.S. Provisional Application No. 60/666,083, filed Mar. 28, 2005, which application is specifically incorporated herein, in its entirety, by reference.

### BACKGROUND OF THE INVENTION

1. Field of the Invention

The present invention relates to the communication of media signals, or more particularly, to a system and method of using a media control center, a data center, and a wide area network (WAN) to establish a multi-point network for transmitting, receiving and editing media signals.

2. Description of Related Art

Media signals (e.g., audio signals, video signals, etc.) are used in a number of different fields to perform a number of different functions. Systems that are traditionally used to transmit media signals can be categorized into one of two diametrically opposed groups: high-end systems that broadcast media signals via airwaves, cable or satellite; and low-end systems that stream (or transmit) media signals via local or wide area networks. The first group of systems, which are extremely expensive, can be used to transmit high quality media signals to a large group of individuals. Such systems are used, for example, by television networks. Typically, a number of media signals (e.g., scenes) are acquired and recorded onto tapes. The tapes are then moved to an editing studio and used to produce a final product (e.g., a compilation of media signals, etc.), which is then transmitted to a viewer's home (e.g., broadcasted via airwaves, cable, satellite, etc.) and played on the viewer's television. The revenue generated by transmitting the media signals to a large audience (e.g., via advertisements, subscriptions, etc.) are typically used to cover operating expenses.

The second group of systems, which are more moderately priced, are typically used to transmit moderate or low quality media signals to small groups of individuals. Such systems are used, for example, in video conferencing. Typically, a camera and a primary communication device are placed in a first conference room and a monitor and a secondary communication device are placed in a second conference room. The camera is then used to capture visuals and audio, which are used to generate a media signal. The signal is then provided to the primary communication device, transmitted (e.g., via a local area network, a wide area network, a telephone line, etc.) to the secondary communication device, and played on the monitor. Through the use of an additional camera and monitor, communication can be made bidirectional.

Such systems can also be used to broadcast a lesson from a classroom to a remote location. Typically, the video camera and the primary communication device are placed in the classroom and the monitor and the secondary communication device are placed at the remote location (e.g., the student's home, etc.). Through the use of a wide area network (e.g., the internet) and a number of monitors and communication devices (e.g., personal computers), the lesson can be transmitted to a number of students at one time.

One drawback of the aforementioned media systems is that expense is directly proportional to quality and complexity (e.g., a low priced system transmits low quality, un-edited signals, etc.). There is currently no media system that is both (i) moderately priced and (ii) can be used to transmit high quality media signals to a group of individuals (large or small). This is especially true if the media signals need to be edited (e.g., in real-time, etc.).

The media systems used by television networks, which can be used to transmit high quality media signals, are extremely (and perhaps prohibitively) expensive. Not only is the equipment used to capture and edit the signals expensive, but so is the equipment (and infrastructure) used to transmit the signals (e.g., broadcast towers, satellites, etc.). An additional drawback of media systems used by television networks is they are only capable of transmitting information one way. In other words, the user is not allowed to respond to (or interact with) the transmitted media signals.

Less expensive media systems, like the ones used in business and education, typically produce moderate or low quality media signals. One reason is because most video conferencing or virtual classroom systems use low resolution cameras, and therefore transmit a media signal that is poor in quality. Even if higher resolution and digital cameras are used, the processing devices used by most network-compatible systems are not capable of receiving and transmitting a high-resolution media signal in real time. Thus, the video received by the viewer is either low-resolution, delayed and/or choppy.

Another drawback of less expensive systems is that the media signals are transmitted “as is.” In other words, this is no editing center where, for example, media signals can be edited to produce a final product (e.g., an edited media signal, a compilation of media signals, etc.). Thus, for example, the transmitted signals do not include fade-ins, fade-outs, media from multiple sources, voiceovers, etc. Another drawback of less expensive systems is that they typically require application specific (or dedicated) hardware and software. Thus, for example, a user interested in sitting in on a video conference would need to either be in their office (where the video conferencing hardware is installed) or have access to such equipment (e.g., traveling with the equipment, etc.).

Thus, it would be advantageous to have a system that is capable of transmitting high quality (and perhaps edited) media signals and overcomes at least one of the aforementioned drawbacks.

### SUMMARY OF THE INVENTION

The present invention provides a system and method of using a media control center, a data center, and a wide area network (WAN) to establish a multi-point network for transmitting, receiving and editing media. Embodiments of the present invention operate in accordance with at least one camera, at least one computer, a media control center, and a data center.

In one embodiment of the present invention, a computer is connected to a camera and a data center via a local area network (LAN). The camera is adapted to capture at least visuals, which are used to generate a first media signal. The first media signal, which may include additional data (e.g., sound data, sensory data, etc.), is then sent to the data center via the LAN. The first media signal is then stored in the data center and provided to a media control center via the LAN.

While the LAN may be constructed using any known material(s) (e.g., copper, fiber optics, wireless transceivers, etc.), there are advantages to a LAN being constructed using materials or devices that have a relatively low (or limited) bandwidth and materials or devices that have a relatively high bandwidth. Preferably, the materials are arranged so that, at any given time, no more than one signal is transmitted over the lower-bandwidth material(s) and multiple signals are (or could be) transmitted over the higher-bandwidth material(s). Such an arrangement, for example, reduces the LAN costs while increasing bandwidth where needed.

In a first embodiment of the present invention, the media control center is adapted to edit the first media signal. In this embodiment, the media control center operates like a traditional editing studio by performing traditional editing functions, perhaps using traditional editing hardware and/or software. Thus, for example, the media control center could be used to produce an edited media signal that includes fade-ins, fade-outs, subtitles, voiceovers, adjustments or enhancements to audio and/or video, etc. The edited media signal is then transmitted back to the data center where it is stored.

In this embodiment, the media control center may include a computer that is connected to editing circuitry (e.g., media patch panels, ANV switches, ANV routers, effects processors, modulators, mixers, media bridges, amplifiers, etc.) and adapted to load (or log onto) a client interface. The client interface may include portions for displaying video, audio and data and controls for editing, storing and monitoring at least one media signal (or types of signals). The media control center may further include at least one display device for displaying (or playing) media signals and a storage device for storing media signals (e.g., individual media signals, a compilation of media signals, etc.). In a preferred embodiment of the present invention, the storage device is a digital video disc (DVD) writer. In an alternate embodiment of the present invention, the storage device is a long-term digital storage device (e.g., hard disk(s), etc.)

In a second embodiment of the present invention, the media control center is further (or alternately) adapted to select a media signal(s) to be transmitted to a plurality of reception devices. More particularly, a media signal(s), as selected by the media control center, is transmitted from the data center to a plurality of reception devices via a wide area network (WAN). In another embodiment of the present invention, the data center is further (or alternately) adapted to transmit the selected media signal to at least one reception device via the LAN. The reception devices may be adapted to access (or display) the transmitted media signal(s) by loading (or logging onto) an alternate client interface. The alternate client interface may include portions for displaying a primary media signal and at least one secondary media signal, wherein the primary media signal is selectable (e.g., by a technician in the media control center, by a user, etc.).

In another embodiment of the present invention, the data center is further adapted to receive feedback signals (text, video, audio, data, etc.) from the plurality of reception devices while the selected media signal is being transmitted (e.g., full-duplex interaction, etc.). The feedback signals, like other media signals, are stored in the data center and provided to the media control center. The feedback signals may then be displayed in the media control center and/or transmitted to the plurality of reception devices. In one embodiment of the present invention, the feedback data (or selected portions) are displayed in a portion of the client interface and/or the alternate client interface.

A more complete understanding of the system and method of using a media control center, a data center, and a WAN to establish a multi-point network for transmitting, receiving and editing media will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 illustrates a media system that operates in accordance with one embodiment of the present invention;

FIG. 2 illustrates a local area network (LAN), as shown in FIG. 1, constructed and arranged in accordance with one embodiment of the present invention;

FIG. 3 illustrates a media control center, as shown in FIG. 1, that can be configured to operate in accordance with embodiments of the present invention;

FIG. 4 illustrates a data center, as shown in FIG. 1, that operates in accordance with one embodiment of the present invention;

FIG. 5 illustrates a method of streaming media in accordance with one embodiment of the present invention;

FIG. 5a illustrates a method of selecting session parameters in accordance with one embodiment of the present invention;

FIG. 6 provides an exemplary screen-shot of a client interface that may be used in embodiments of the present invention; and

FIG. 7 provides an exemplary screen-shot of an alternate client interface that may be used in embodiments of the present invention.

### DETAILED DESCRIPTION OF THE PREFERRED EMBODIMENT

The present invention provides a system and method of using a media control center, a data center, and a wide area network (WAN) to establish a multi-point network for transmitting, receiving and editing media. Embodiments of the present invention operate in accordance with at least one camera, at least one computer, a media control center, and a data center. In the description that follows, like element numerals are used to describe like elements illustrated in one or more figures.

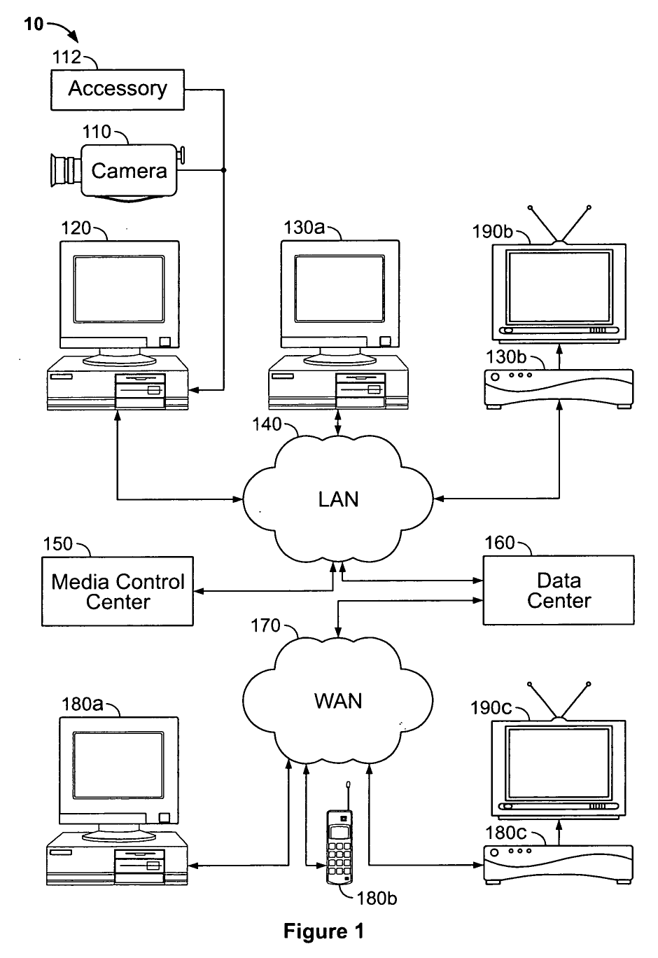

A media system that operates in accordance with a first embodiment of the present invention is shown in FIG. 1. Specifically, the media system 10 includes a computer 120 connected to a camera 110 and a data center 160 via a local area network (LAN) 140. The camera 110 is adapted to capture at least visuals, which are used to generate a first media signal. The first media signal, which may either be generated by the camera 110 and received by the computer 120, or generated by the computer 120, is then sent to the data center 160 via the LAN 140. It should be appreciated that while certain advantages are achieved by routing the first media signal to the data center 160 via the LAN 140, the present invention is not so limited. Thus, for example, a data center 160 that alternately (or also) receive media signals via a non-network connection or a WAN 170 is within the spirit and scope of the present inventions. Such an embodiment could be used, for example, to capture visuals from a remote location (e.g., a classroom, foreign country, etc.).

In an alternate embodiment of the present invention, the media system further (or alternately) includes at least one accessory 112 for capturing information that cannot be captured (at least accurately) by the camera. For example, if the video camera does not include a microphone, the accessory 112 could include a microphone for capturing audio. By way of another example, the accessory 112 could include a sensor for capturing sensory data (e.g., temperature, wind, humidity, pressure, location, time, chemical composition, structural composition, etc.). Thus, a barometer could be used to capture pressure data, a global positioning system (GPS) receiver could be used to capturing location data, etc.

It should be appreciated that the information captured by the accessory 112 could either be the first media signal, incorporated into the first media signal or transmitted as a separate signal. It should also be appreciated that the cameras depicted and discussed herein include, but are not limited to, all media acquisition devices (e.g., digital, analog, video, etc.) generally known to those skilled in the art. It should further be appreciated that the computers depicted and discussed herein include, but are not limited to, personal computers (desktop or laptop), stand-alone networking devices, and all other computing and routing devices (with and without displays) generally known to those skilled in the art.

It should also be appreciated that the present invention is not limited to a media system that includes a single camera. Multiple cameras can be used to create multiple media signals (e.g., each one signifying a different angle, perspective, image, location, etc.). Such a system may include an equal number of computers and cameras, providing a one-to-one correspondence. If less computers are used, at least one computer should be connected to more than one camera.

In one embodiment of the present invention, the computer 120 is further adapted to encode the first media signal into a lossless compressible format, as known to those skilled in the art. The encoded signal is then transmitted to the data center 160 via the LAN 140. In should be appreciated, however, that the present invention is not limited to the use of encoded (or encrypted) data, data that is encoded using a particular algorithm, or data that is encoded into a particular format. Thus, for example, a media system that utilizes (and transmits) raw data (e.g., signals, etc.) is within the spirit and scope of the present invention.

Once the first media signal is received by the data center 160, the signal is then provided to the media control center 150. In a preferred embodiment of the present invention, the first media signal is both stored in the data center 160 and transmitted to the media control center 150 via the LAN 140. It should be appreciated that while this method of routing the first media signal to the media control center is advantageous (as discussed below), the present invention is not so limited. For example, the media control center 150 may alternately (or also) receive media signals from the data center 160 via a non-network connection, from the data center 160 via a WAN 170, or from the computer 120 via the LAN 140.

Regardless of how the signals are transmitted to the media control center 150, the signals can either be transmitted automatically or upon request. In other words, the data center 160 may either transmit (e.g., automatically, in response to a condition, etc.) the first media signal (in its entirety) or information pertaining to the first media signal (e.g., descriptive information, a portion of the signal, etc.). With respect to the latter, the information can be used by the media control center 150 to request the entire signal.

In a first embodiment of the present invention, the media control center 150 is used to edit media signals. In this embodiment, the media control center 150 operates like a traditional editing studio by performing traditional editing functions, perhaps using traditional editing hardware and/or software (modulators, effects processors, editing software, etc.). Thus, for example, the media control center could be used to produce an edited media signal that includes fade-ins, fade-outs, subtitles, voiceovers, adjustments or enhancements to audio and/or video, etc. The edited media signal is then transmitted back to the data center 160 where it is stored. It should be appreciated that the edited media signal can either be transmitted back to the data center 160 after it has been edited (in its entirety) or while it is being edited (in a looping fashion). For example, with respect to the latter, a first portion of the signal could be received, edited, and transmitted back to the data center 160 while a second portion of the signal is being received.

In a second embodiment of the present invention, the media control center 150 is further adapted to select media signals (e.g., via a request to the data center, etc.) that are to be transmitted to local and/or remote users. More particularly, the media signals, as identified or ordered by the media control center 150, are transmitted from the data center 160 to a plurality of reception devices (i.e., 180a-c) via the WAN 170 (e.g., the internet, a TCP/IP network, etc.). Each reception device is either adapted to play the media signals (e.g., if the device includes a display device and/or speakers) or relay the media signals to a display device (e.g., 190c) where the signals are then displayed (or played). It should be appreciated that the reception devices depicted and discussed herein include, but are not limited to, personal computers (desktop or laptop), set top boxes, personal digital assistants (PDAs), mobile phones, wireless information devices, and all other computing or routing devices generally known to those skilled in the art. In should further be appreciated that the display devices depicted and discussed herein include, but are not limited to, monitors, televisions (tube, plasma, LCD, etc.), and all other video and/or audio reproduction devices generally known to those skilled in the art.

In another embodiment of the present invention, the media system 10 further includes at least one reception device connected to the LAN 140. Specifically, the data center 160 is further adapted to transmit the selected media signals (as transmitted over the WAN 170) to at least one reception device (i.e., 130a-b) via the LAN 140. Such a system allows, for example, a lesson from a classroom to be transmitted both locally (with respect to the data center 160) (e.g., to another classroom, etc.) and remotely (e.g., to a student's home, etc.).

It should be appreciated that the LAN depicted and described herein can be constructed using any materials generally known to those skilled in the art. Materials commonly used in LANs are electrically conductive materials (e.g., copper, etc.), optically transmissive materials (e.g., fiber optics, etc.), and wireless devices (e.g., low-speed and high-speed wireless transceivers, etc.). While optically transmissive materials, for example, are superior in performance to electrically conductive materials (e.g., greater bandwidth, etc.), they are also more expensive. Therefore, in one embodiment of the present invention, the LAN is constructed using both materials (or devices) that have relatively low (or limited) bandwidth (“low-bandwidth materials”) and materials (or devices) that have relatively high bandwidth (“high-bandwidth materials”). The materials are then arranged to optimize performance.

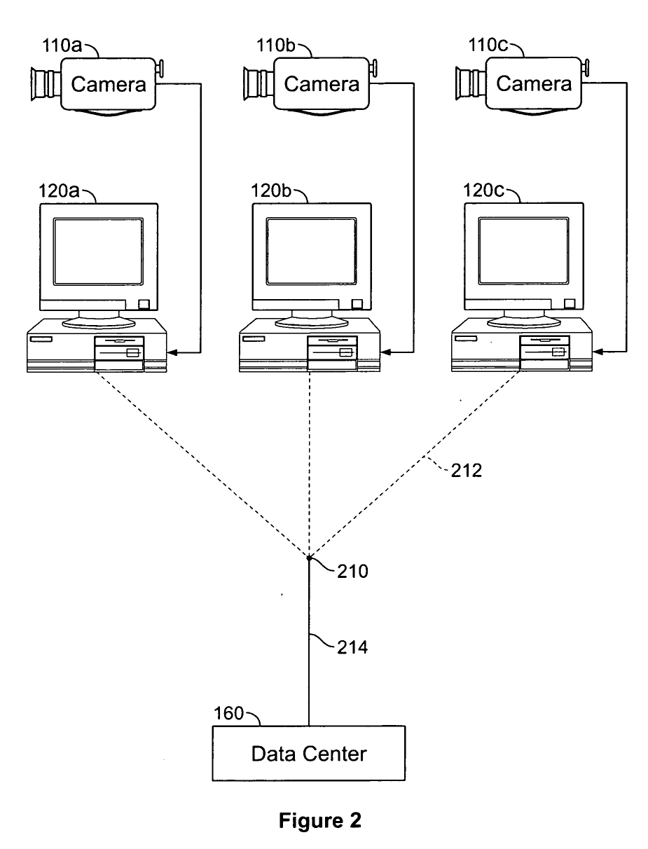

Such an embodiment is shown, for example, in FIG. 2. In this embodiment, the LAN is constructed using two types of materials: (1) low-bandwidth materials 212 (shown by dashed lines) and (2) high-bandwidth materials 214 (shown by solid lines). The materials are arranged so that, at any given time, no more than one signal is transmitted over the low-bandwidth material and multiple signals are (or could be) transmitted over the high-bandwidth material.

As shown in FIG. 2, the low-bandwidth material 212 is used to transmit individual media signals from three discretely located video cameras (i.e., 110a-c) and computers (i.e., 120a-c) to a central node 210. The high-bandwidth material 214 is then used to transmit the multiple media signals from the central node 210 to the data center 160. In a preferred embodiment of the present invention, the low-bandwidth material is either an electrically conductive material (e.g., copper, aluminum, silver, gold, etc.) or a low-speed wireless transceiver(s) (e.g., Bluetooth transceiver, etc.) and the high-bandwidth material is either an optically transmissive material (e.g., fiber optics, etc.) or a high-speed wireless transceiver(s) (e.g., Wi-Fi transceiver, etc.). It should be appreciated that the number and type of components depicted in FIG. 2 are not limitations of the present invention, but are merely provided to illustrate one way in which multiple media signals can be transmitted to a data center. Thus, for example, a media system that includes additional components (e.g., additional cameras, additional computers, components for connecting the LAN to external devices, components (e.g., switches) for converting between electrical, optical and/or wireless signals (e.g., at node 210), etc.) is within the spirit and scope of the present invention.

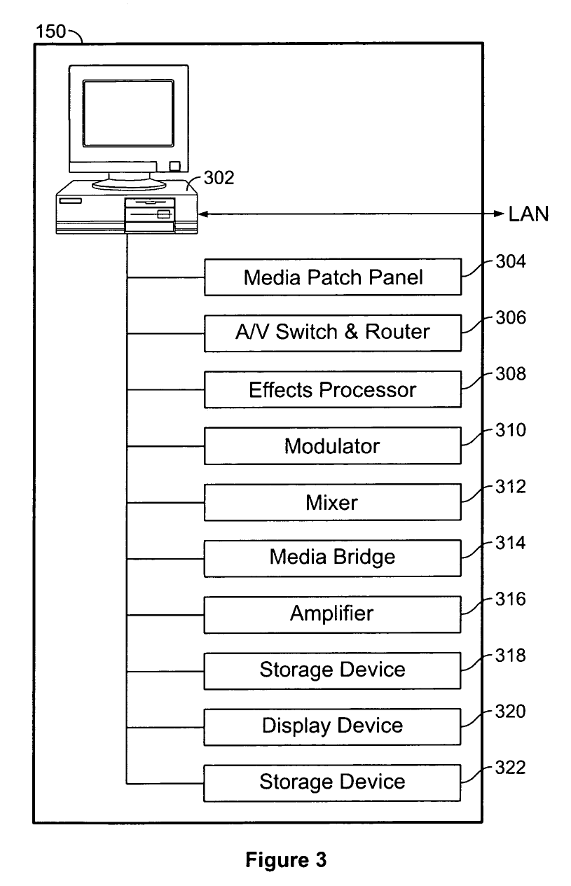

As previously stated, the media control center is where media signals are, at least in certain embodiments, edited. FIG. 3 illustrates a media control center 150 that can be configured to operate in accordance with embodiments of the present invention. Specifically, in a first embodiment of the present invention, the media control center 150 includes a computer 302 that is connected to the LAN (not shown) and adapted to receive and edit at least one media signal. In this embodiment, editing software (e.g., software for filtering, transitioning, enhancing, mixing, receiving, switching, etc.) generally known to those skilled in the art is operating on the computer 302 and used to produce edited media signals.

In a second embodiment of the present invention, the media control center further includes editing circuitry, which may include at least one media patch panel 304, audio/video switch and/or router 306, effects processor 308, modulator 310, mixer 312, media bridge 314, and/or amplifier 316. The media patch panel 304 and audio/video switch and/or router 306 are used to route (manually and/or automatically) media signals through at least the remaining editing circuitry, which includes devices that are generally known to those skilled in the art and commonly used to edit audio and video. For example, the effects processor 308 is used to perform functions that include, but are not limited to, audio expansion, gate equalization, video phase correction, and transition modification (e.g., fading in, fading out, etc.). By way of another example, the modulator 310 is used to perform functions that include, but are not limited to, channel expansion, compression, peak limitation, phase delineation, and tone generation.

As previously discussed, the editing circuitry shown in FIG. 3 can either be configured to edit a signal prior to the signal being transmitted back to the data center or while it is being received from and transmitted to the data center (i.e., in a looping fashion). It should be appreciated that the number, location and arrangement of the devices depicted in FIG. 3 are not limitations of the present invention, but are merely provided to illustrate one way in which the present invention may operate. Thus, for example, a media control center that includes additional or fewer devices (e.g., multiple amplifiers, a recording studio for capturing video and/or audio, a media player (e.g., DVD, VCR, DVtape, etc.) for playing prerecorded video and/or audio, media patch panel, etc.) is within the spirit and scope of the present invention. It should also be appreciated that the present invention is not limited to any particular type of device shown in FIG. 3 (e.g., 304-316) and includes all devices (e.g., all amplifiers, mixers, etc.) generally known to those skilled in the art.

In a third embodiment of the present invention, the media control center 150 further comprises at least one display device 320 adapted to display (or play) media signals (e.g., first media signal, edited media signal, etc.). The particular media signal displayed on the display device 320 may be controlled by the media patch panel 304, the computer 302, or an alternate switching device (not shown).

In a fourth embodiment of the present invention, the media control center 150 further includes a storage device 322 for storing media signals that are received, edited, and/or transmitted to local and/or remote users (e.g., individual media signals, compilations of media signals, etc.). For example, transmitted media signals can be stored on the storage device 322 before they are transmitted, at substantially the same time as they are transmitted, or any time thereafter. In one embodiment of the present invention, the storage device 318 is connected (at least electrically) to the amplifier 316. In this embodiment, at least two sets of amplifiers may be used: one for editing media signals (e.g., increasing/decreasing signal amplitude, unifying signal quality, etc.); and one for storing media signals (e.g., conditioning a media signal for storage on multiple storage devices, etc.).

In a preferred embodiment of the present invention, the storage device 322 is a digital video disc (DVD) writer. In alternate embodiments of the present invention, the storage device includes, but is not limited to, a video cassette recorder (VCR), a reel-to-reel recorder, random access memory (RAM), a hard disk drive (or other mass storage device), a compact disc (CD), a mini-disk (MD) or any other (long or short term) storage device (including combinations thereof, such as RAID devices) generally known to those skilled in the art. The stored signals, for example, can then be sent (or sold) to interested individuals or archived, which may or may not be made available via the WAN or LAN.

It should be appreciated that the aforementioned four embodiments are not exclusive embodiments, and may be combined in any manner. Thus, for example, a media control center 150 may include a computer 302 for editing certain features of a media signal and an effects processor 308 for editing other features. It should further be appreciated that the location of the devices depicted in FIG. 3 are not limitations of the present invention, but are merely provided to illustrate one way in which the devices may be arranged. Thus, for example, a media control center 150 that includes a storage device 322 that is located outside the media control center 150 (e.g., in the data center, etc.) is within the spirit and scope of the present invention. It should also be appreciated that any or all of the devices included in the media control center may be programmed to operate automatically or may require human intervention.

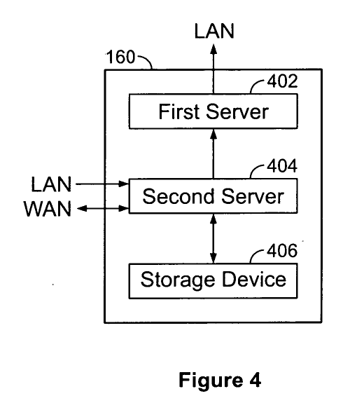

In a preferred embodiment of the present invention, as previously discussed, the media signals are routed through the data center. A data center that operates in accordance with one embodiment of the present invention is illustrated in FIG. 4. In this embodiment, the data center 160 includes a first server 402, a second server 404 and a storage device 406.

With reference to FIGS. 1 and 4, the first media signal is transmitted from the computer 120 to the data center 160, or more particularly the second server 404, via the LAN 140. The signal is then stored on the storage device 406 and transmitted to the media control center 150 via the first server 402 and the LAN 140. Signals stored on the storage device are then transmitted (as instructed by the media control center 150) to the plurality of reception devices 180a-c via the second server 404 and the WAN 170. The same signals are also transmitted to the plurality of reception devices 130a-b via the first server 402 and the LAN 140. It should be appreciated that the present invention is not limited to the number or location of devices and connections (or interconnections) depicted in FIG. 4. Thus, for example, a data center that includes a single server for transmitting signals over the LAN and WAN, a first server that operates independently from a second server, a separate device for managing the storage of signals in the storage device, or additional devices common to data centers (e.g., work stations, switches, patch panels, backup devices, additional servers, firewalls, routers, etc.) is within the spirit and scope of the present invention.

With reference to FIG. 4, the media signals (including real-time media signals, edited media signals, media signals from other sources, etc.) are stored on the storage device 406 and can easily be made available to reception devices located on both the LAN and WAN. Select signals stored in the storage device 406 are queued up to be transmitted in a particular order by the media control center 150. Thus, for example, in the course of a news program, a first media signal pertaining to an automobile show that took place earlier that day could be stored on the storage device 406. A live second media signal from a news anchor could be looped through the media control center 150 where it is edited (e.g., faded in, introductory music added, etc.) and stored on the storage device 406. The media control center 150 could then send a request to the data center to transmit the second media signal as edited (i.e., the edited media signal). Because of the looping feature, the signal can be transmitted almost immediately after it is edited. Once the news anchor comments on the automobile show, the media control center 150 could then send a request to the data center to transmit the first media signal (i.e., the prerecorded media on the automobile show). While the media control center 150 (or a technician located therein) is busy editing and selecting media signals, the local and/or remote users (e.g., at the reception devices 130a-b, 180-a-c, respectively) are experiencing a seamless (and preferably high quality) compilation of media signals.

In another embodiment of the present invention, the data center may be further adapted to receive data (e.g., feedback data, etc.) from at least one of the reception devices. In a preferred embodiment of the present invention, the data is received while the media signal(s) is being transmitted to the reception device(s) (e.g., providing full-duplex interaction, etc.). For example, with reference to FIGS. 1 and 4, and using the aforementioned example of the virtual classroom, a student located at reception device 180a may use a video camera (not shown) to record or capture a question. The reception device 180a could then transmit the video question to the data center 160 via the WAN 170. In one embodiment of the present invention, the second server 404 receives the video question, stores the video question in the storage device 406, and transmit the video question (or information pertaining to the video question) to the media control center 150 (e.g., via the LAN). The video question could then be played on the display device in the media control center and/or transmitted to the plurality of reception devices via the WAN and/or LAN (e.g., automatically, if selected for transmission, etc.).

By way of another example, a student located at reception device 180c (which may have a slower network connection and no camera) may use a keyboard to ask a question. The reception device 180c could then transmit the text question to the media control center 150 via the WAN 170 and the data center 160. The text question could then be displayed and/or transmitted as previously discussed.

In another embodiment of the present invention, the data center may further be adapted to receive prerecorded data from at least one of the reception devices. For example, with reference to FIGS. 1 and 4, a user located at reception device 180a may transmit prerecorded audio/video data to data center 160 via the WAN 170. If the data is received in a format (e.g., Flash Video (FLV) format) that is compatible with the media system's interface (see, e.g., alternate client interface below), then the data may be transmitted to the plurality of reception devices without first having to be reformatted. If, however, the data is received in a format that is not compatible with the media system's interface, then the data may be transmitted to the media control center 150 and converted (or edited) into a compatible format before it is transmitted to the plurality of reception devices.

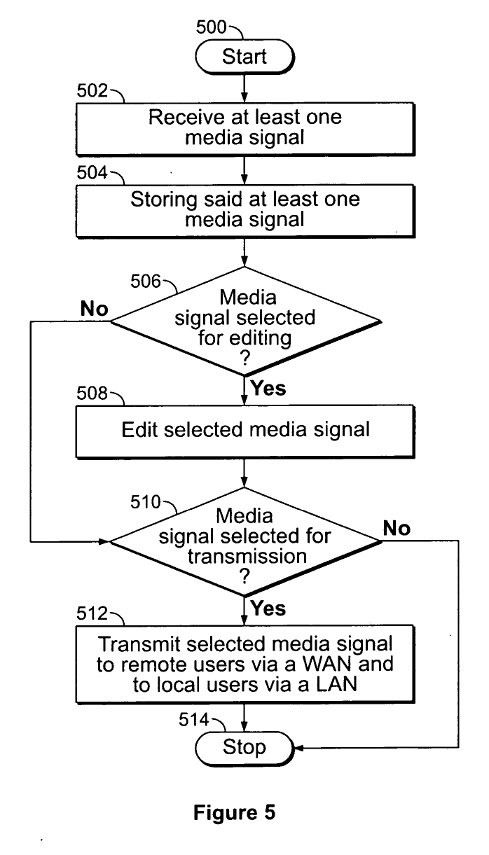

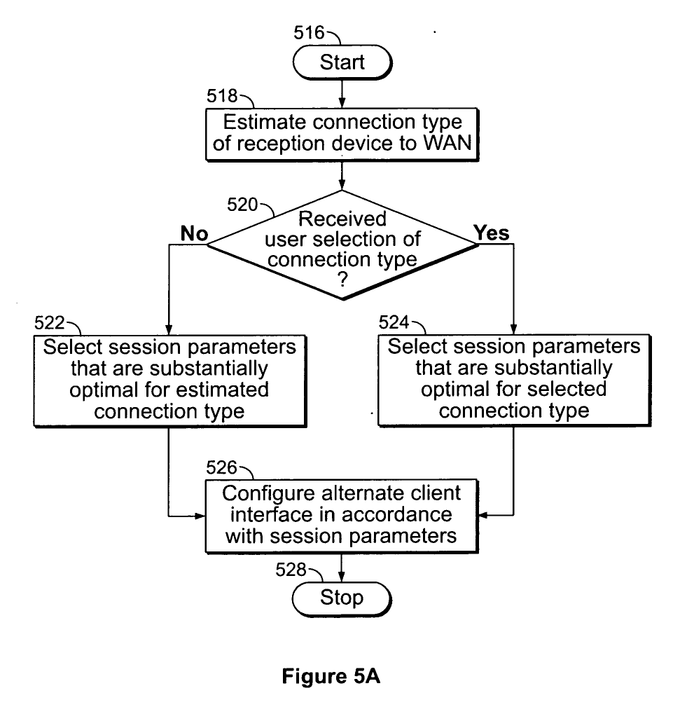

A method of transmitting (e.g., streaming, etc.) media signals in accordance with one embodiment of the present invention is illustrated in FIG. 5. Specifically, the process starts at step 500, and media signals (e.g., live signals, prerecorded signals, edited signals, feedback signals, etc.) are received at step 502. The media signals are then stored at step 504 and a determination is made as to whether a media signal has been selected for editing at step 506. Such a selection may be made, for example, from previous transmitted media signals or information pertaining to stored media signals (e.g., a list of stored signals, etc.). If it is determined that a media signal has not been selected, then the process jumps to step 510. However, if it is determined that a media signal has been selected, then the selected media signal is edited at step 508.

At step 510, a determination is made as to whether a media signal has been selected for transmission. If it is determined that a media signal has not been selected, then the process ends at step 514. However, if it is determined that a media signal has been selected, then the selected media signal is transmitted at step 512, and the process ends at step 514. In embodiments of the present invention, the media signals are transmitted to remote users via a WAN and/or local users via a LAN.

By using networks (e.g., LAN, WAN) to connect the various components depicted and described herein (e.g., media sources, data center, media control center, reception devices, etc.), the present invention can be flexibly configured. The media control center, for example, could be connected to the LAN and located anywhere on the studio lot or connected to the WAN and located anywhere in the world. Unlike traditional media systems, which transmit media point-to-point (e.g., from a business in Burbank, Calif. to a business in Los Angeles, Calif.), the present invention can be configured to transmit media over a multi-point network (e.g., from a school in Berkley, Calif., to a media control center in Santa Barbara, Calif., to a home in Seattle, Wash.).

Not only does such a system provide flexibility, but it can also be used to provide stand-alone support for what otherwise would be a point-to-point media transmission. In the aforementioned example of a virtual classroom, traditional video conferencing equipment allows a teacher to transmit a real-time, un-edited media signal (typically of poor to moderate quality) from a first point (e.g., a classroom) to a plurality of second points (e.g., student homes). In contradistinction, the present invention allows the teacher to transmit a real-time, un-edited media signal (of high quality) from a first point (e.g., a classroom) to a second point (e.g., a media control center). The un-edited media is then edited (e.g., according to a protocol provided by the teacher) and transmitted to a plurality of third points (e.g., student homes). The media control center could further be adapted to receive feedback data (e.g., questions, comments, etc.) from the students and to transmit the feedback data (or portions thereof) to the teacher and/or other students.

In one embodiment of the present invention, a technician is allowed to operate the media control center by logging onto a website (or loading an application). A client interface (e.g., webpage, window, etc.) would allow the technician to select media signals to be edited and/or transmitted. With respect to the prior, the client interface may also allow the technician to edit the selected media signals. The editing may be performed using software and/or hardware as previously discussed. With respect to the latter, the client interface may also allow the technician to select at least one primary media signal, at least one secondary media signal, and/or at least one feedback signal.

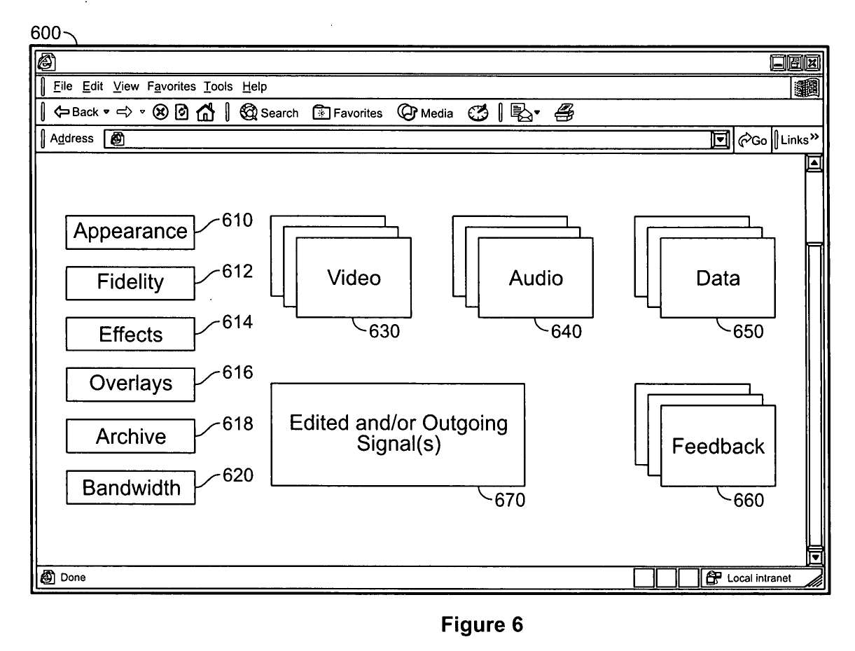

An exemplary client interface is shown in FIG. 6. In this embodiment, the client interface 600 includes a video portion 630, an audio portion 640, a data portion 650, and a feedback portion 660. These portions can be used to show signals that are received by and/or stored in the data center (or information pertaining thereto). In a preferred embodiment of the present invention, the video portion 630 is used to display signals that include at least a video component (e.g., signals from a camera, etc.), the audio portion 640 is used to display signals that include at least an audio component (e.g., signals from a microphone, etc.), the data portion 650 is used to display signals that include at least a data component (e.g., signals from a sensor, etc.), and the feedback portion 660 is used to display signals provided by the reception devices (e.g., feedback signals, etc.). The technician can use these portions to select signals to be transmitted and/or edited.

The signal(s) that is currently being transmitted can be shown in the edited and/or outgoing signal(s) portion 670 of the client interface 600. In an alternate embodiment of the present invention, this portion can alternately (or also) be used to display a signal(s) that is being edited. Signals can be edited, for example, through the use of controls located on the client interface 600. For example, an appearance control 610 can be selected to edit brightness, contrast, sharpness, gamma, etc., a fidelity control 612 can be selected to edit balance, gain, equalization, etc., an effects control 614 can be selected to edit reverb, transitions (e.g., fading, dissolving, wiping, etc.), etc., and an overlay control 616 can be selected to add subtitles, translations, voiceovers, etc. The client interface 600 may also include an archive control 618 for storing a media signal(s) and a bandwidth control 620 for viewing and/or controlling bandwidth associate with a media signal(s) (e.g., a transmitted signal, received audio signals, etc.).

It should be appreciated that client interface depicted in FIG. 6 is not a limitation of the present invention, but merely provided to illustrate one way in which media signals can be edited and selected for transmission. Thus, a media system that does not include a client interface or includes a client interface that comprises different portions and/or controls is within the spirit and scope of the present invention. By way of example, dedicated display devices may be used to display certain media signals (e.g., video signals, feedback signals, etc.), media signals may be displayed in thumbnail format, etc.

In a preferred embodiment of the present invention, the client interface is webpage-based and scalable. Such a system would allow anyone (e.g., a technician, a teacher, a user, etc.) to log onto to a website, provide security information (e.g., password, cookies, etc.), and receive an client interface that includes specific controls and/or portions (e.g., as necessary to perform a function, as previously customized, etc.). Such an embodiment would allow, for example, a technician to access the client interface shown in FIG. 6 from any location, provided that there is sufficient network access (e.g., a high-speed internet connection, etc.).

Such an embodiment would also allow a user to access an alternate version of the client interface shown in FIG. 6. The alternate client interface may include, for example, a primary media portion, a secondary media portion, and/or a feedback portion. The primary media portion could be used to display a particular media signal (e.g., as selected by the technician, the user, etc.), the secondary media portion could be used to display other media signals, and the feedback portion could be used to display feedback signals and/or submit feedback data (e.g., typing text, etc.). The alternate client interface may also be adapted to detect capabilities of the recipient device in which it is operating on. Capabilities may include, for example, the type of feedback related equipment that is connected to the recipient device (e.g., cameras, microphones, etc.) and the speed (or type) of the recipient device's network connection. The network connection information could then be used to modify the signals being transmitted and/or received. For example, transmitted media signals could be encoded differently, fewer media signals could be received, etc.

Such an interface could allow a user to play an active role in viewing media signals. By way of example, a court proceeding could be captured and transmitted using a plurality of video cameras (e.g., one on the witness, one of the defendant, etc.). The alternate client interface could be used to select the court proceeding (i.e., the program of interest) and display multiple media signals (e.g., in thumbnail format, etc.). The user could then select one of the media signals as a primary media signal, which would be displayed prominently on the alternate client interface. A feedback portion could be used to display questions or comments from other users. If the user wanted to view the proceedings from a different angle, for example, the user could change the primary media signal by interacting with the alternate client interface (e.g., by selecting one of the secondary media signals, etc.).

It should be appreciated that the term “alternate client interface” is used herein to describe a client interface that has been scaled for a particular individual and/or function, and is not used to describe a particular client interface. Thus, for example, an alternate client interface that includes a plurality of video portions (e.g., for showing students in a virtual classroom, etc.), a feedback signal portion (e.g., for displaying (or playing) student questions and/or comments, etc.), and/or a feedback control (e.g., for selecting individual student questions and/or comments that are to be transmitted to all (or select) students, etc.) is within the spirit and scope of the present invention.

In one embodiment of the present invention, the alternate client interface (or webpage) is Macromedia Flash-based. Such an embodiment is advantageous in that it allows a user to play media signals without having to download dedicated software. This is because most computers already include a web-browser or Flash-player plug-in.

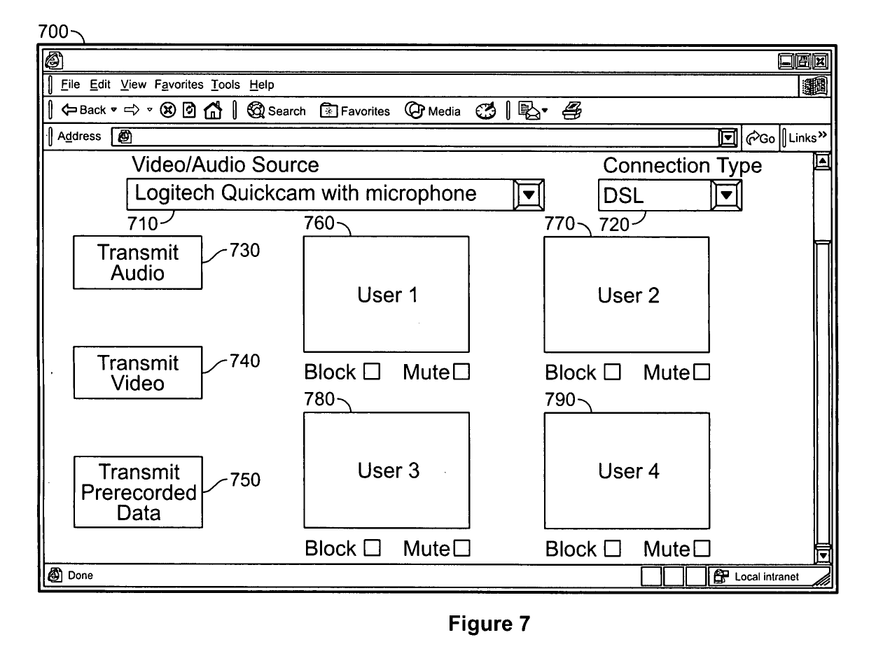

It should be appreciated that while the present invention has been described in terms of a virtual classroom, it is not limited to such an embodiment. The present invention, for example, may be used to create and/or participate in any virtual session (e.g., a presentation, conference, meeting, chat-room, etc.). By way of example, and with reference to FIG. 7, a user may participate in a session by activating the session (e.g., pointing their browser to the session's URL, pointing their browser to a URL and selecting the session (e.g., by typing in or clicking on a unique session identifier), etc.) and providing login information (e.g., user ID, password, etc.). The user may then be able to configure the alternate client interface 700 for the session by selecting, for example, the window (e.g., 760, 770, etc.) that the user would like to occupy, the camera/microphone that the user would like to use (e.g., 710), and session parameters (e.g., frames-per-second, number of key frames, audio data-rate, screen mode (e.g., color depth), screen resolution, etc.) (not shown). The alternate client interface 700 may then be adapted to allow the user to participate in the session (e.g., receive, transmit and/or play media signals). In doing so, the alternate client interface 700 may either transmit media signals automatically or allow the user to select media signals that should be transmitted (e.g., 730-750). The alternate client interface 700 may also be adapted to allow the user to control their media signals and/or control other participants' media signals. Thus, for example, the user may be able to mute their microphone, block a participant's video signal, etc..

In one embodiment of the present invention, the alternate client interface 700 may further be adapted to receive prerecorded data (e.g., audio/video data, etc.) from the user's reception device and transmit prerecorded data to the other participants (e.g., via the data center) (see, e.g., 750). If the prerecorded data is received in a format that is compatible with the alternate client interface (e.g., Flash Video (FLV) format), then the data can transmitted to the other participants without first having to be reformatted. If, however, the prerecorded data is not received in a compatible format, then the data should be transmitted to the media control center (FIG. 1, ref. 150) so that it can be reformatted (e.g., edited) into a compatible format. The reformatting is preferably accomplished in real-time.

The alternate client interface may also be adapted to receive prerecorded data from a resource (as opposed to a storage device) that is attached to the user's reception device if the resource is defined in the operating system's driver pool as a Camera/Scanner resource. For example, the alternate client interface may be adapted to recognize a DVD player that is attached to the user's reception device if the DVD player is supported by a WDM driver. The DVD player could then be used to transmit audio/video data from a DVD to the data control center. The audio/video data would then be reformatted into a compatible format transmitted to the participants in the session (either including or excluding the user), and played in a window (e.g., primary window, default window, selected window, etc.).

It should be appreciated that the term “window,” as used herein, includes, but is not limited to, a web browser, any area included therein, and all other scrollable and non-scrollable computer viewing areas generally known to those skilled in the art. For example, in one embodiment of the present invention, the alternate client interface (or webpage) includes one window for each participant in the session. Thus, for example, and with reference to FIG. 7, if four users are participating in a session, then the alternate client interface 700 may include four windows (e.g., 760-790). Furthermore, if the first user wants to play (or share) prerecorded data, then the prerecorded data may be displayed (either automatically or selectively) in the first, second, third or forth user's window, in a newly-created fifth window (which may be opened automatically by the alternate client interface or manually by the user) (not shown), or in a new web browser (not shown).

In another embodiment of the present invention, and in an effort to simply the alternate client interface 700, the interface is adapted to allow the user to select a connection type (e.g., dial-up, DSL, LAN, connection speed, connection speed range, etc.) (see, e.g., 720) instead of (or in addition to) session parameters (e.g., frames-per-second, number of key frames, etc.), wherein each connection type is linked to predetermined session parameters that are substantially optimized for a corresponding connection type. In another embodiment of the present invention, the interface may be adapted to estimate the user's connection type (e.g., based on response delay, historical information, etc.) and select session parameters that are substantially optimized for the estimated connection type.

It should be appreciated that these embodiments are not exclusive embodiments, and may be used alone or in combination. By way of example, FIG. 5a illustrates a method of selecting session parameters in accordance with one embodiment of the present invention. Specifically, starting at step 516, the reception device's connection type (e.g., DSL, connection speed, connection speed range, etc.) is estimated at step 518. It is then determined, at step 520, whether the user has selected a particular connection type. If the answer is NO, then session parameters (e.g., frames-per-second, number of key frames, etc.) are selected that are substantially optimized for the estimated connection type at step 522. If the answer, however, is YES, then session parameters are selected that are substantially optimized for the user-selected connection type at step 524. In a preferred embodiment of the present invention, each connection type is linked (e.g., in a database) to session parameters that are substantially optimized for a corresponding connection type. In an alternate embodiment of the present invention, an algorithm is used to select session parameters that are substantially optimized for a particular connection type. At step 526, the user interface is configured in accordance with the selected session parameters, ending the process at step 528.

In another embodiment of the present invention, the alternate client interface may select a particular connection type, or limit the user's selection of a connection type, based at least in part on the connection types of the other participants in the session. For example, if four out of five reception devices are adapted to communicate over a DSL line, and a fifth reception device is adapted to communicate over a LAN line, then it may be advantageous to set (or restrict) the fifth reception device's session parameters to those that are substantially optimized for DSL, so that all participants are using the same session parameters. Not only does such an embodiment promote uniformity, but it also limits the effects of bandwidth fluctuation, which can be detrimental to real-time activities, such as video streaming.

Because multiple users are often participating in a single session, it may be advantageous to implement functions and/or filters to reduce session echoes. For example, it may be advantageous for the alternate client interface to calculate and programmatically apply an inverted Probability Density Function (PDF), which can be thought of as a programmable filter. This function can be evoked programmatically from a dynamic link library (DLL) and applied to the data stream to suppress the weaker echo signals, which are often attenuated as echoes are reverberated from user to user.

In a session where one user is the primary speaker and the other users are participants, it may also be beneficial for the users to use (or the alternate client interface to require or suggest) short-range microphones, headphones and/or selective muting to limit echoes. For example, the alternate client interface may require the presenter to use a short-range microphone that is adapted to pick up the presenter's voice, but not sounds that are transmitted by the presenter's speakers. By way of another example, the alternate client interface may requires participants to use headphones and/or mute their microphones to prevent the presentation from being echoed from user to user.

In one embodiment of the present invention, the media system may further include an application (e.g., operating in the data center, media control center, etc.) that is in communication with the alternate client interface and is adapted to perform one or more of the functions identified herein. Thus, for example, the data center may include an application that is adapted to estimates a reception device's connection type and/or evoke an inverted PDF from a DLL to suppress echo (or noise) signals.

Having thus described embodiments of a system and method of using a media control center, a data center, and a WAN to establish a multi-point network for transmitting, receiving and editing media, it should be apparent to those skilled in the art that certain advantages of the system have been achieved. It should also be appreciated that various modifications, adaptations, and alternative embodiments thereof may be made within the scope and spirit of the present invention. The invention is defined solely by the following claims.

What is claimed is:

1. A multi-point media network comprising:
a video camera adapted to capture optical information and to use said optical information to generate a first media signal;
a first computer operatively connected to said video camera and adapted to receive said first media signal from said video camera and to transmit said first media signal to a data center;
said data center operatively connected to said first computer and a wide area network (WAN) and adapted to receive said first media signal from said first computer and to store said first media signal in a storage device; and
a media control center operatively connected to said data center and adapted to:
receive said first media signal from said data center;
edit at least a portion of said first media signal to generate a second media signal; and
transmit said second media signal and a request to broadcast a final media signal, which includes at least a portion of said second media signal, to said data center, said data center being further adapted to broadcast said final media signal to at least one reception device via said WAN in response to receiving said request.

2. The multi-point media network of claim 1, wherein said edit function is selected from a list consisting of amplification, video phase correction, audio expansion, audio equalization, and transition modification.

3. The multi-point media network of claim 1, wherein said video camera is further adapted to capture audio and to use said optical information and said audio to generate said first media signal.

4. The multi-point media network of claim 1, further comprising a microphone operatively connected to said first computer and adapted to capture audio, said first computer being further adapted to receive said audio from said microphone and to transmit said audio to said data center.

5. The multi-point media network of claim 1, further comprising a sensor operatively connected to said first computer and adapted to capture sensor data, said first computer being further adapted to receive said sensor data from said sensor and to transmit said sensor data to said data center.

6. The multi-point media network of claim 5, wherein said sensor data is selected from a list consisting of temperature, humidity, wind, pressure, location, time, chemical composition, and structural composition data.

7. The multi-point media network of claim 1, further comprising a plurality of video cameras adapted to capture optical information and audio and to use said optical information and audio to generate a plurality of media signals.

8. The multi-point media network of claim 7, wherein said plurality of media signals are stored in said storage device and said data center is further adapted to transmit information to said media control center that at least identifies said plurality of media signals.

9. The multi-point media network of claim 7, wherein said request further comprises broadcasting said final media signal as a primary media signal and at least a portion of at least one of said plurality of media signals as a secondary media signal, said data center being further adapted to broadcast said final media signal as a primary media signal and said at least a portion of said at least one of said plurality of media signals as a secondary media signal to said at least one reception device via said WAN in response to said request.

10. The multi-point media network of claim 7, wherein first computer is further connected to a local area network (LAN) and further adapted to transmit said first media signal to said data center via said LAN.

11. The multi-point media network of claim 1, wherein said first computer is further connected to said WAN and further adapted to transmit said first media signal to said data center via said WAN.

12. The multi-point media network of claim 1, wherein said media control center is further connected to a local area network (LAN) and further adapted to receive said first media signal from said data center via said LAN.

13. The multi-point media network of claim 1, wherein said media control center is further connected to said WAN and further adapted to receive said first media signal from said data center via said WAN.

14. The multi-point media network of claim 10, further comprising at least one reception device connected to said LAN, said data center being further adapted to transmit said final media signal to said at least one reception device via said LAN.

15. The multi-point media network of claim 10, further comprising said LAN, wherein said LAN comprises a low-bandwidth material and a high-bandwidth material and is arranged so that individual media signals are transmitted over said low-bandwidth material and multiple media signals are transmitted over said high-bandwidth material.

16. The multi-point media network of claim 15, wherein said low-bandwidth material comprises an electrically conductive material and said high-bandwidth material comprises an optically transmissive material.

17. The multi-point media network of claim 1, wherein said media control center comprises:
audio/video editing circuitry adapted to edit said at least a portion of said first media signal to generate said second media signal; and
a second computer adapted to receive said first media signal from said data center, loop said first media signal through said audio/video circuitry, and transmit said second media signal to said data center.

18. The multi-point media network of claim 17, wherein said audio/video editing circuitry includes at least two components selected from a list consisting of effects processors, modulators, mixers, and amplifiers.

19. The multi-point media network of claim 17, wherein said second computer is further adapted to store a media signal on a storage medium, said storage medium being selected from a list of mediums consisting of compact discs (CDs), digital video discs (DVDs), mini-discs (MDs), hard disk drives, and random access memory.

20. The multi-point media network of claim 1, wherein said data center is further adapted to receive feedback data from said at least one reception device while said final media signal is being transmitted over said WAN, wherein said feedback data is selected from a list consisting of text, audio and video data.

21. The multi-point media network of claim 1, wherein said media control center further comprises a second computer and a client interface operating on said second computer, said client interface including at least one control for editing said first media signal and a portion for displaying a media signal selected from a list consisting of said first, second and final media signals.

22. The multi-point media network of claim 1, further comprising said at least one reception device and an alternate client interface operating on said at least one reception device and including at least a primary media signal portion and a secondary media signal portion.

23. The multi-point media network of claim 1, further comprising said at least one reception device and an alternate client interface operating on said at least one reception device, said alternate client interface being Flash-based, thereby allowing said at least one reception device to participate in a session if said at least one reception device includes a web browser and a Flash-player plug-in.

24. The multi-point media network of claim 23, wherein said alternate client interface is adapted to receive a user name, password, and session-selection information, wherein said session-selection information identifies a particular session that a user of said at least one reception device would like to join.

25. The multi-point media network of claim 23, wherein said alternate client interface includes a plurality of windows and is adapted to transmit video and audio data to said data center and to receive window-identification information, camera-identification information and microphone-identification information from a user of said at least one reception device, wherein said camera-identification information identifies a camera that said at least one reception device will use to capture said video data, said microphone-identification information identifies a microphone that said at least one reception device will use to capture said audio data, and said window-identification information identifies one of said plurality of windows in which said video data will be played,

26. The multi-point media network of claim 23, wherein said alternate client interface is adapted to receive at least two session parameters, said at least two session parameters being selected from a list consisting of frames-per-second, number of key frames, audio data-rate, screen mode and screen resolution.

27. The multi-point media network of claim 23, wherein said alternate client interface is adapted to estimate said at least one reception device's connection type to said WAN and to select at least two session parameters based on said estimated connection type, said at least two session parameters being selected from a list consisting of frames-per-second, number of key frames, audio data-rate, screen mode and screen resolution.

28. The multi-point media network of claim 23, wherein said alternate client interface is adapted to receive connection-type information from a user of said at least one reception device and to select at least two session parameters based on said connection-type information, said connection-type information being selected from a list consisting of DSL, LAN and dial-up, and said at least two session parameters being selected from a list consisting of frames-per-second, number of key frames, audio data-rate, screen mode and screen resolution.

29. The multi-point media network of claim 23, wherein said alternate client interface is adapted to transmit video and audio data to said data center, receive video and audio data from said data center, and receive media-control information from a user of said at least one reception device, said media-control information being selected from a list consisting of muting said received audio data, blocking said received video data, muting said transmitted audio data, and blocking said transmitted video data.

30. The multi-point media network of claim 23, wherein said alternate client interface is further adapted to receive prerecorded audio/video data from said at least one reception device in a non-Flash-Video (FLV) format and transmit said prerecorded audio/video data to said data center, said media control center being adapted to reformat said prerecorded audio/video data to a Flash-Video (FLV) format so that it can be played on said alternate client interface.

31. The multi-point media network of claim 30, wherein said alternate client interface is further adapted to receive said prerecorded audio/video data from a DVD player connected to said at least one reception device, wherein said DVD player is supported by a WDM driver.

32. The multi-point media network of claim 23, wherein said alternate client interface is further adapted to calculate and programmatically apply an inverted Probability Density Function (PDF) to said final media signal to suppress weaker noise signals that are included therein.

33. A multi-point media network comprising:
first and second cameras adapted to capture optical information and to use said optical information to generate first and second media signals, respectively;
a first computer operatively connected to said first camera and a local area network (LAN) and adapted to receive said first media signal from said first camera;
a second computer operatively connected to said second camera and said LAN and adapted to receive said second media signal from said second camera;
a media control center comprising at least a third computer, said media control center being adapted to:
receive at least one of said first and second media signals;
edit at least a portion of at least one of said first and second media signals; and
select a final media signal to be transmitted to a plurality of reception devices via a wide area network (WAN), said final media signal including at least a portion of at least one of said first, second and edited media signals; and
a data center connected to said LAN and in communication with said media control center, comprising:
a storage device;
a first server adapted to:
receive said first and second media signals from said first and second computer, respectively, via said LAN;
receive said edited media signal from said media control center;
store said first, second and edited media signals in said storage device; and
transmit said final media signals to said plurality of reception devices via said WAN.

34. The multi-point media network of claim 33, wherein said first and second cameras are further adapted to capture audio and to use said optical information and said audio to generate first and second media signals, respectively.

35. The multi-point media network of claim 33, further comprising a microphone operatively connected to said first computer and adapted to capture audio, said first computer being further adapted to incorporate said audio into said first media signal.

36. The multi-point media network of claim 33, further comprising a sensor operatively connected to said first computer and adapted to capture sensor data, said sensor data being selected from a list consisting of temperature, humidity, wind, pressure, location, time, chemical composition, and structural composition data.

37. The multi-point media network of claim 33, further comprising said LAN, said LAN comprising:
a low-bandwidth material adapted to transmit a single media signal at any one time, said single media signal being selected from said first and second media signals; and
a high-bandwidth material adapted to transmit both said first and second media signals at any one time.

38. The multi-point media network of claim 33, wherein said edit function is selected from a list consisting of amplification, video phase correction, audio expansion audio equalization, and transition modification.

39. The multi-point media network of claim 33, wherein said data center is further adapted to transmit information pertaining to data stored in said storage device.

40. The multi-point media network of claim 39, wherein said information pertaining to said first and second media signals comprises a portion of said first and second media signals.

41. The multi-point media network of claim 33, wherein said media control center is further adapted to identify an order media signals are to be transmitted to said plurality of reception devices via said WAN, said media signals including at least portions of at least two of said first, second and edited media signals.

42. The multi-point media network of claim 33, wherein said final media signal is identified as a primary media signal, said primary media signal being transmitted to said plurality of reception devices and displayed more prominently than other media signals.

43. The multi-point media network of claim 33, wherein said media control center further comprises editing circuitry operatively connected to said third computer, said editing circuitry including at least two device selected from a list consisting of a media patch panel, media switch, media router, effects processor, modulator, mixer, media bridge, and amplifier.

44. The multi-point media network of claim 33, wherein said third computer is further adapted to store a compilation of media signals including said final media signal on a storage device, said storage device being selected from a list consisting of a digital video disc (DVD) writer, a video cassette recorder (VCR), a hard disk drive, and random access memory.

45. The multi-point media network of claim 33, wherein said first server is further adapted to received a plurality of feedback signals from at least one of said plurality of reception devices via said WAN and to store said plurality of feedback signals on said storage device.

46. The multi-point media network of claim 45, wherein said third computer is adapted to receive said plurality of feedback signals from said data center and select at least one of said plurality of feedback signals that is to be transmitted to said plurality of reception devices via said WAN.

47. The multi-point media network of claim 33, further comprising a client interface operating on said third computer, said client interface including at least one interactive icon for editing said at least a portion of said at least one of said first and second media signals and at least one window for displaying a media signal, said media signal being selected from a list consisting of said first, second and edited media signals.

48. The multi-point media network of claim 47, wherein said client interface is stored on said third computer as an application.

49. The multi-point media network of claim 47, wherein said client interface is a webpage provided by said data center.

50. The multi-point media network of claim 33, further comprising an alternate client interface operating on said plurality of reception devices, said alternate client interface including a portion for displaying a primary media signal and at least one secondary media signal, said primary media signal being displayed more prominently than said at least one secondary media signal.

51. The multi-point media network of claim 50, wherein said alternate client interface is further adapted to allow a user to select said primary media signal from said at least one secondary media signal.

52. A method of transmitting media, said method comprising the steps of:
capturing optical information and using said optical information to generate first and second media signals;
transmitting said first and second media signals to a data center;
storing said first and second media signals;
transmitting at least one of said first and second media signals to a media control center, said media control center being adapted to perform editing functions;
editing at least a portion of said at least one of said first and second media signals;
transmitting said edited media signal and a transmission request to said data center, said transmission request identifying a final media signal to be transmitted to a plurality of reception devices via a wide area network (WAN), said final media signal including at least a portion of one of said first, second and edited media signals;
storing said edited media signal;
transmitting said final media signal to said plurality of reception devices via said WAN.

53. The method of claim 52, wherein said step of capturing optical information further comprises capturing optical information and audio and using said optical information and audio to generate said first and second media signals.

54. The method of claim 52, wherein said step of transmitting at least one of said first and second media signals to a media control center further comprises transmitting said at least one of said first and second media signals to said media control center via said WAN.

55. The method of claim 52, wherein said step of transmitting said first and second media signals to a data center further comprises transmitting said first and second media signals to said data center via said WAN.

56. The method of claim 52, further comprising the steps of:
storing a compilation of media signals in a database, said compilation including at least said final media signal; and
making said database available to said plurality of reception devices via said WAN.

57. The method of claim 52, further comprising the steps of storing a compilation of media signals on a digital video disc (DVD) at substantially the same time as said compilation is being transmitted over said WAN, said compilation including at least said final media signal.

58. The method of claim 52, further comprising the steps of:
receiving text data related to said final media signal from at least one of said plurality of reception devices; and
displaying said text data in said media control center.

59. The method of claim 52, further comprising the steps of:
receiving audio data related to said final media signal from at least one of said plurality of reception devices; and
playing said audio data in said media control center.

60. The method of claim 52, further comprising the steps of:
receiving video data related to said final media signal from at least one of said plurality of reception devices; and
playing said video data in said media control center.

61. The method of claim 52, further comprising the steps of:
transmitting a plurality of other media signals to said plurality of reception devices via said WAN;
selecting a primary media signal from said plurality of other media signals and said final media signal;
designating said non-selected media signals as secondary media signals; and
displaying said primary media signal more prominently than any one of said secondary media signals.

62. The method of claim 52, wherein said step of transmitting said final media signal to said plurality of reception devices via said WAN further comprising transmitting said final media signal in a Flash-Video (FLV) format.

63. The method of claim 52, further comprising the step of a user joining a session before said user's one of said plurality of reception devices plays said final media signal, comprising:
providing a user name;
providing a password; and
providing session-selection information, said session-selection information being used to identify a particular session that said user would like to join.

64. The method of claim 52, further comprising the step of configuring an interface that includes a plurality of windows and is adapted to transmit video and audio data to said data center and to play said final media signal, comprising:
providing camera-identification information, said camera-identification information identifying a camera that will be used to capture said video data;
providing microphone-identification information, said microphone-identification information identifying a microphone that will be used to capture said audio data; and
providing window-identification information, said window-identification information identifying one of said plurality of windows in which said video data will be played.

65. The method of claim 52, further comprising the step of configuring an interface that is adapted to play said final media signal, comprising providing at least two session parameters, said at least two session parameters being selected from a list consisting of frames-per-second, number of key fames, audio data-rate, screen mode and screen resolution.

66. The method of claim 52, further comprising the step of configuring an interface that is adapted to play said final media signal, comprising:
estimating at least one of said plurality of reception devices' connection type to said WAN, said connection type being selected from a list consisting of DSL, LAN and dial-up; and
selecting at least two session parameters based on said estimated connection type, said at least two session parameters being selected from a list consisting of frames-per-second, number of key frames, audio data-rate, screen mode and screen resolution.

67. The method of claim 52, further comprising the step of configuring an interface that is adapted to play said final media signal, comprising:
providing connection-type information, said connection-type information being selected from a list consisting of DSL, LAN, cable and dial-up; and
selecting at least two session parameters based on said connection-type information, said at least two session parameters being selected from a list consisting of frames-per-second, number of key frames, audio data-rate, screen mode and screen resolution.

68. The method of claim 52, further comprising the step of controlling an interface that is adapted to transmit video and audio data to said data center and receive video and audio data from said data center, comprising providing media-control information, said media-control information being selected from a list consisting of muting said received audio data, blocking said received video data, muting said transmitted audio data, and blocking said transmitted video data.

69. The method of claim 52, further comprising the step of calculating and programmatically applying an inverted Probability Density Function (PDF) to said final media signal to suppress weaker noise signals that are included therein.
